(19) United States
(12) Patent Application Publication
(10) Pub. No.: US 2016/0126548 A1
(43) Pub. Date: May 5, 2016

(54) SPHERICAL PARTICLES, PRODUCTION THEREOF AND USE

(71) Applicant: BASF SE, Ludwigshafen (DE)

(72) Inventors: Simon SCHROEDLE, Westfield, NJ (US); Oliver WAGNER, Philippsburg (DE); Kai DOERING, Kleinniedesheim (DE); Aleksei VOLKOV, Ludwigshafen (DE)

(73) Assignee: BASF SE, Ludwigshafen (DE)

(21) Appl. No.: 14/889,577

(22) PCT Filed: Apr. 30, 2014
(86) PCT No.: PCT/EP2014/058775

§ 371 Date: Nov. 6, 2015

(30) Foreign Application Priority Data
May 8, 2013 (EP) 13167011.9

(51) Int. Cl. H01M 4/505; H01M 4/525; C01G 53/00

(52) U.S. Cl. CPC H01M 4/505; C01G 53/006; H01M 4/525; C01P 2004/61

(57) ABSTRACT

Spherical particles comprising a lithiated mixed transition metal oxide comprising nickel, cobalt and manganese and optionally at least one further transition metal, each in cationic form, wherein the carbonate content, calculated as Li₂CO₃, is in the range from 0.01 to 0.3% by weight, based on overall particles, and the proportion of nickel, plotted against the radius of the particles in question, in the outer region of the particles is at least 10 mol % below the proportion in the core, and the manganese content, plotted against the radius of the particles in question, in the outer region of the particles is at least 10 mol % above the proportion in the core, and where mol % are based on the total transition metal content.

The present invention relates to spherical particles comprising a lithiated mixed transition metal oxide of the general formula (I):

Li₁₊ₓ(NiₐCo_{b}Mn_{c}M_{d})₁₋ₓO₂ (I)

in which the variables are each defined as follows:
M is Mg or Al and/or one or more transition metals selected from Ti, Fe, Cr and V,
a is in the range from 0.45 to 0.55,
b is in the range from 0.17 to 0.34,
c is in the range from 0.15 to 0.35,
d is in the range from zero to 0.2,
where: a+b+c+d=1,
x is in the range from 0.005 to 0.2, preferably 0.01 to 0.06,
wherein the carbonate content, calculated as Li₂CO₃, is in the range from 0.01 to 0.3% by weight, based on overall particles, and the proportion of nickel, plotted against the radius of the particles in question, in the outer region of the particles is at least 10 mol % below the proportion in the core, and the manganese content, plotted against the radius of the particles in question, in the outer region of the particles is at least 10 mol % above the proportion in the core, and where mol % are based on the total transition metal content.

The present invention further relates to a process for producing the inventive spherical particles. The present invention further relates to lithiated mixed transition metal oxides which can be produced with the aid of inventive particles, and to the use of lithiated mixed transition metal oxides thus produced.

Storing energy has long been a subject of growing interest. Electrochemical cells, for example batteries or accumulators, can serve to store electrical energy. As of recently, lithium ion batteries have enjoyed particular interest. They are superior to the conventional batteries in some technical aspects. For instance, they can be used to produce voltages unobtainable with batteries based on aqueous electrolytes.

In lithium ion batteries, the materials from which the electrodes are made, and more particularly the material from which the cathode is made, play an important role.

In many cases, lithium-containing mixed transition metal oxides are used as the active material, especially lithium-containing nickel-cobalt-manganese oxides. These are generally produced by first producing a precursor, for example a mixed carbonate or mixed hydroxide of manganese, nickel and cobalt, and mixing the precursor with a lithium compound, for example with Li₂CO₃, and then treating it thermally at temperatures in the range from 800 to 1000° C.

US 2012/0080649 proposes a process in which a precursor is produced, this having a rising manganese concentration over the cross section of its particles. However, the procedure disclosed is comparatively inflexible and costly to implement on the industrial scale.

It is desirable in many cases to achieve high nickel contents of the mixed transition metal oxides because such materials have a high capacity and a high energy density. However, nickel-rich materials in many cases have reduced thermal stability.

Some authors propose solving such problems by using what are called gradient materials or core-shell materials. For instance, Y.-K. Sun et al. in J. Mater. Sci. 2011, 21, 10108 and in Y.-K. Sun et al., Adv. Funct. Mater. 2010, 20, 485 propose materials having a very high nickel content, the particles having a nickel content of 83 mol % and the core having a nickel content of 90 mol %. However, cycling stability still leaves something to be desired in some cases, as does processability. It is noticeable that the core-shell material in some cases is obtained in the form of hard agglomerates which have a diameter in the millimeter range, in the centimeter range or higher and which have to be divided by complex grinding steps.

The problem addressed was thus that of providing electrode materials which have a high capacity and a high energy density combined with high thermal stability and good processability. A further problem addressed was that of providing a process by which electrodes can be obtained with high capacity and high energy density combined with high thermal stability and good processability. A further problem addressed was that of providing uses for electrode materials having a high capacity and a high energy density coupled with high thermal stability and good processability.

Accordingly, the spherical particles defined at the outset have been found, these also being referred to as inventive spherical particles or inventive particles for short, and being processable particularly efficiently to give electrode materials having the desired properties.

It has been observed that, specifically in many of the unwanted hard agglomerates, an above-average high content of carbonate is found when the starting material used is mixed transition metal carbonate or lithium carbonate is chosen as a lithium source. In the case of use of hydroxides as precursors too, undesirably high carbonate concentrations usually result from absorption of carbon dioxide from the air in industrial operation.

Inventive particles have a spherical form. In this context, spherical particles shall include not just those which are exactly spherical but also those particles in which the maximum and minimum diameters of at least 95% (numerical average) of a representative sample differ by not more than 25% and which preferably have neither corners nor edges.

Inventive particles may have a median diameter (D50) in the range from 0.1 to 35 μm, preferably 1 to 30 μm and more preferably 2 to 20 μm, measured, for example, by light scattering. Suitable equipment is commercially available, for example Malvern Mastersizer.

In one embodiment of the present invention, inventive particles are those having a narrow particle diameter distribution. A narrow particle diameter distribution can be defined, for example, such that the ratio of the median diameters (D10)/(D50) is at least 0.5 and the ratio (D90)/(D50) is not more than 1.6.

Inventive particles may be present in the form of agglomerates of primary particles. Corresponding primary particles may, for example, have a mean diameter in the range from 50 nm to 500 nm.

Inventive particles have few, if any, measurable proportions of agglomerates of secondary particles. In one embodiment of the present invention, the proportions of agglomerates of secondary particles are within the range of 0.1% by weight or lower, said agglomerates having a diameter in the range from 0.05 mm to 1 cm. Preferably, the proportions of agglomerates of secondary particles are within the range of 0.1% by weight or less, the agglomerates mentioned having a diameter in the range from 0.032 mm to 1 cm.

Inventive particles are particles of mixed transition metal oxide comprising nickel, cobalt and manganese and optionally at least one further transition metal, each in cationic form, and additionally lithium.

Inventive particles have an average composition corresponding to the following formula (I):

Li₁₊ₓ(NiₐCo_{b}Mn_{c}M_{d})₁₋ₓO₂ (I)

in which the variables are each defined as follows:
M is Mg or Al and/or one or more transition metals selected from Ti, Fe, Cr and V,
a is in the range from 0.45 to 0.55,
b is in the range from 0.17 to 0.34,
c is in the range from 0.15 to 0.35,
d is in the range from zero to 0.2, preferably from zero to 0.05,
where: a+b+c+d=1,
x is in the range from 0.005 to 0.2, preferably 0.01 to 0.06.

In inventive particles, the carbonate content, calculated as Li₂CO₃, is in the range from 0.01 to 0.3% by weight, preferably to 0.2% by weight, based on overall particles. The carbonate content can be determined by methods known per se, for example by release of CO₂ from an amount of sample in a glass cuvette and measurement of the amount of CO₂ via infrared absorption in the glass cuvette. Alternative options are titration methods, for example acid/base titrations.

Figures in % by weight are each preferably based on the average value of a sample, for example on samples of several spherical particles having different diameters.

In one embodiment of the present invention, the concentration of nickel in inventive particles is in the range from 40 to 80 mol %, preferably in the range from 45 to 55 mol %, determined for the total nickel content of the inventive particle in question, where mol % is based on all transition metals. In the context of the present invention, this does not rule out the possibility that the concentration of nickel ions at some points in the particle in question is below 40 mol % or above 80 mol %.

In one embodiment of the present invention, the concentration of manganese in inventive particles is in the range from 10 to 50 mol %, preferably in the range from 15 to 35 mol %, determined for the total manganese content of the inventive particle in question, where mol % is based on all transition metals. In the context of the present invention, this does not rule out the possibility that the concentration of manganese ions at some points in the particle in question is below 10 mol % or above 50 mol %.

In one embodiment of the present invention, the cobalt content, plotted against the radius of the particles in question, is essentially constant. This shall be understood to mean that the cobalt content varies by not more than 5 mol %, based on all transition metals.

In a very particularly preferred embodiment, inventive particles have a composition in which the variables a, b, c and d are defined as follows: a=0.5, b=0.2, c=0.3 and d=zero.

Inventive particles have a core and an outer region.

In inventive particles, the proportion of nickel, plotted against the radius of the particles in question, in the outer region of the particles is at least 10 mol % below the proportion in the core. In addition, in inventive particles, the manganese content, plotted against the radius of the particles in question, in the outer region of the particles is at least 10 mol % above the proportion in the core. These molar percentages are based on the total content of transition metal in the inventive particle in question.

“Core” is understood to mean the inner region of inventive particles which makes up to 50% by weight, preferably up to 25% by weight, of the overall inventive particle and in which the concentrations of nickel and manganese, in each case over the diameter of inventive particle, is essentially constant. The “outer region” is accordingly the part of inventive particle which is not core. In the outer region, there is accordingly a gradient in the composition, especially with regard to the concentrations of nickel and manganese. The gradient in the composition may extend up to the outer surface of the inventive particle. In another embodiment of the present invention, the outer region may have a region of constant composition which makes up preferably not more than 10% by weight of the inventive particle and which forms the outer surface of the inventive particle in question.

In one embodiment of the present invention, the core makes up at least 5% by weight, preferably at least 10% by weight, based on inventive particles.

In one embodiment of the present invention, the concentrations of nickel and manganese, plotted against the radius of the particles in question, do not have any turning points.

In one embodiment of the present invention, the concentrations of nickel and manganese, plotted against the radius of the particles in question, do not have any extreme values.

In one embodiment of the present invention, the composition of the respective primary particles is homogeneous in each case.

In one embodiment of the present invention, inventive particles have a BET surface area in the range from 0.1 to 1 m²/g, measured by nitrogen adsorption after outgassing of the sample at 200° C. for at least 30 minutes and otherwise on the basis of DIN ISO 9277.

In one embodiment of the present invention, inventive particles have a mean pore volume in the range from 0.2 to 0.5 ml/g, determined by Hg porosimetry for pore diameters in the range from 0.005 μm to 20 μm.

In one embodiment of the present invention, inventive particles have a mean pore volume in the range from 0.01 to 0.1 ml/g, determined by Hg porosimetry for pore diameters in the range from 0.005 μm to 0.1 μm.

In one embodiment of the present invention, inventive particles have a tamped density in the range from 1.8 kg/l up to 2.7 kg/l.

In a preferred embodiment of the present invention, inventive particles have a tamped density of at least (1.65+0.03·(D50)/μm) kg/l and at most (2.30+0.03−(D50)/μm) kg/l.

The tamped density is determined essentially to DIN 53194 or DIN ISO 787-11. However, in a departure from the standard, measuring cylinders having a volume of 25 ml or 50 ml are used and 2000 tamping operations are conducted.

Inventive particles are of very good suitability as or for production of electrode material for lithium ion batteries. The capacities attainable are values in the range from 150 to 170 mA-h/g for C/5. Inventive particles are obtained in very good morphology and have excellent processability.

The present invention further provides a process for producing inventive particles, also called inventive production process for short. The procedure for performance of the inventive production process involves performing the following steps (a) to (f):
(a) providing at least one aqueous solution of at least one precipitant selected from at least one alkali metal carbonate or at least one alkali metal hydrogencarbonate or at least one alkali metal hydroxide,
(b) providing at least two aqueous solutions (B1) and (B2) of transition metal salts, solution (B1) comprising at least three transition metal salts selected from nickel salts, cobalt salts and manganese salts, and solution (B2) comprising at least two transition metal salts selected from cobalt salts and manganese salts, and optionally a nickel salt, the aqueous solutions (B1) and (B2) having different molar ratios of nickel and manganese,
(c) performing a precipitation of mixed transition metal carbonates, transition metal hydroxides or transition metal carbonate hydroxides in a stirred tank cascade of at least two stirred tanks or in a stirrer vessel, bringing about the precipitation given different transition metal concentrations by
(c1) feeding solutions (B1) and (B2) into different stirred tanks in the stirred tank cascade or by
(c2) feeding solutions (B1) and (B2) into the stirred vessel at different times,
(d) removing the spherical particles thus precipitated,
(e) mixing them with at least one lithium compound selected from LiOH, Li₂O and Li₂CO₃,
(f) converting them at a temperature in the range from 800 to 1000° C.

The inventive production process thus has steps (a) to (f). Step (c) can be executed as variant (c1) or (c2).

The steps will be described in detail individually.

To perform step (a), at least one alkali metal hydroxide, for example potassium hydroxide or preferably sodium hydroxide, or at least one alkali metal carbonate or alkali metal hydrogencarbonate, is dissolved in water. The corresponding solution is also called “solution (A)” in the context of the present invention.

Examples of alkali metal hydroxide, alkali metal carbonate and alkali metal hydrogencarbonate are selected from sodium hydroxide, potassium hydroxide, sodium carbonate, potassium carbonate, sodium hydrogencarbonate and potassium hydrogencarbonate, and from mixtures thereof.

In one embodiment of the present invention, solution (A) has a concentration of alkali metal hydroxide in the range from 1 to 50% by weight, preferably 10 to 25% by weight. In another embodiment of the present invention, solution (A) has a concentration of alkali metal (hydrogen)carbonate in the range from 1% by weight to a maximum of a saturated solution; in the case of NaHCO₃ up to about 10% by weight, in the case of Na₂CO₃ up to 21.5% by weight, each at 20° C., or more at a correspondingly higher temperature.

In one embodiment of the present invention, an excess of alkali metal hydroxide is used, based on transition metal. The molar excess may, for example, be in the range from 1.001:1 to 1.5:1.

In one embodiment of the present invention, an excess of alkali metal (hydrogen)carbonate is used, based on transition metal. The molar excess may, for example, be in the range from 1.05:1 to 10:1.

Solution (A) may comprise at least one compound L. Compound L may serve as a ligand for at least one of the transition metals. For example, L may be an organic amine or especially ammonia. In the context of the present invention, water should not be regarded as a compound L.

In one embodiment of the present invention, a concentration of L, especially of ammonia, in the range from 0.05 to 1 mol/l, preferably 0.1 to 0.7 mol/1 is selected. Particular preference is given to amounts of ammonia for which the solubility of Ni²⁺ in the mother liquor is not more than 1000 ppm, more preferably not more than 500 ppm.

For performance of step (b), at least two different solutions (B1) and (B2) are made up, solution (B1) comprising at least three transition metal salts selected from nickel salts, cobalt salts and manganese salts, and solution (B2) comprising at least two transition metal salts selected from cobalt salts and manganese salts, and optionally a nickel salt, the aqueous solutions (B1) and (B2) having different molar ratios of nickel and manganese. “Water-soluble” is understood to mean that the transition metal salts in question dissolve in distilled water at 20° C. to an extent of at least 10 g/l, preferably at least 50 g/mol. Examples are halides, nitrates, acetates and especially sulfates of nickel, cobalt and manganese, and optionally of titanium, vanadium, chromium, iron, each preferably in the form of the aquo complexes thereof, and additionally also magnesium and aluminum.

In one embodiment of the present invention, the aqueous solutions (B1) and (B2) comprise cations of at least three different transition metals.

For the aqueous solutions (B1) and (B2), the concentrations can be selected within wide ranges. The concentrations are preferably selected such that they are, in total, within the range from 1 to 1.8 mol of transition metal/kg of solution, more preferably 1.5 to 1.7 mol of transition metal/kg of solution. In addition, up to 0.1 mol of magnesium or up to 0.1 mol of aluminum may be present in the form of water-soluble salts, each calculated per kg of solution.

In solution (B2), the ratio of the concentrations of Mn²⁺ to Ni²⁺ is higher than in solution (B1).

The aqueous solutions (B1) and (B2) may have a pH in the range from 4 to 7.

Preferably, neither aqueous solution (B1) nor aqueous solution (B2) comprises compound L.

For example, the transition metals nickel, cobalt and manganese may be present in solution (B1) in a molar ratio of 5.9:2.0:2.1, and in solution (B2) in a ratio of 3.5:2.0:4.44. In other embodiments, in the case of 2 molar parts of cobalt, for example, 5 to 7.5 molar parts of nickel and 0.01 to 3 molar parts of manganese may be present in solution (B1). In solution (B2), based on 2 molar parts of cobalt, for example, 0.001 to 4 molar parts of nickel and 3 to 7 molar parts of manganese may be present.

The sequence of steps (a) and (b) is as desired.

In step (c), a precipitation of mixed transition metal carbonates, transition metal hydroxides or transition metal carbonate hydroxides is conducted in a stirred tank cascade of at least two stirred tanks or in a stirred vessel, the precipitation being performed at different transition metal concentrations, specifically at transition metal concentrations which are different at different places or times.

For this purpose, the following variants can be selected:
(c1) feeding solutions (B1) and (B2) into different stirred tanks in a stirred tank cascade or by
(c2) feeding solutions (B1) and (B2) into a stirred vessel at different times, or in different amounts.

The performance of step (C) brings about precipitations at different transition metal concentrations. This is understood to mean that different concentrations of transition metal cations and different ratios of the concentrations of the transition metal cations used are present in the liquid phase over time—variant (c2)—or locally—variant (c1). The ratio of the concentrations of the transition metal cations used present at particular points in the stirred tank cascade or at a particular time of precipitation in the stirred vessel then determines the composition of the different layers or points in the inventive particles.

During step (c), it is also possible to meter in solution (A), without or preferably with compound L.

The procedure for performance of step (c) is preferably to work with varying molar ratios of at least two of the transition metal cations, for example Ni²⁺, Mn²⁺ and optionally Co²⁺, during the precipitation, the concentration of Ni²⁺ cations decreasing and that of the Mn²⁺ cations increasing, and the concentration of Co²⁺ preferably remaining essentially constant.

The procedure is preferably to initially charge a stirred vessel with an aqueous solution comprising compound L and, in one phase of step (c), to meter in a solution (B1) comprising nickel salt, manganese salt and cobalt salt and optionally at least one salt of metal M, and simultaneously solution (A). The metered addition is controlled such that the pH of the mother liquor is in the range from 10.5 to 11.3. Then a solution (B2) comprising nickel salt, manganese salt and cobalt salt in another molar composition is metered in, and optionally at least one salt of metal M, and simultaneously further solution (A) comprising at least one alkali metal hydroxide or at least one alkali metal carbonate or at least one alkali metal hydrogencarbonate. These two solutions (A) may be the same or different.

The procedure is more preferably to initially charge an aqueous solution comprising compound L in a stirred vessel and, in one phase of step (c), to meter in a solution (B1) comprising nickel salt, manganese salt and cobalt salt, and simultaneously solution (A). The metered addition is controlled such that the pH of the mother liquor is in the range from 10.5 to 11.3. Then an aqueous solution (B1) and additionally aqueous solution (B2) comprising nickel salt, manganese salt and cobalt salt in a different molar composition than (B1) is metered in, and simultaneously a further solution (A) comprising at least one alkali metal hydroxide or at least one alkali metal carbonate or at least one alkali metal hydrogencarbonate. The metered addition of aqueous solution (B2) may commence gradually or abruptly. The metered addition of aqueous solution (B2) can be effected in addition to or instead of the metered addition of aqueous solution (B1).

In a preferred embodiment of the present invention, a stirred vessel is initially charged with an aqueous solution comprising compound L. During the performance of step (c), solution (B1) and solution (B2) are each metered in at metering rates which change over time.

In one embodiment of the present invention, the procedure is to initially charge an aqueous solution comprising compound L in a stirred vessel and, in one phase of step (c), to meter in a solution (B1) comprising nickel salt, manganese salt and cobalt salt, and simultaneously solution (A). In the course of this, solution (B1) passes through a static mixer before entering the stirred vessel. Subsequently, solution (B2) is metered into the static mixer and mixes therein with solution (B1) passing through. The mixture thus obtainable is then metered—rather than solution (B1)—into the stirred vessel.

In a particular embodiment, solution (B1) can be mixed with solution (B2) before entry into the stirred vessel, for example in a static mixer, and the mixture thus obtainable—rather than solutions (B1) and (B2)—can be metered into the stirred vessel.

In one embodiment of the present invention, neither the concentration of Ni²⁺ nor that of Mn²⁺ passes through a turning point during the precipitation.

In one embodiment of the present invention, step (c) of the inventive production process is performed at temperatures in the range from 10 to 85° C., preferably at temperatures in the range from 20 to 50° C.

In one embodiment of the present invention, step (c) of the inventive production process is performed at a pH in the range from 8 to 12, preferably 10.5 to 11.8 and more preferably to 11.3. The pH in the course of performance of step (c) may be essentially constant or increase by up to 0.2 unit or decrease by up to 0.5 unit or vary within a range of 0.2 unit.

In one embodiment of the present invention, step (c) of the inventive production process is performed at a pressure in the range from 500 mbar to 20 bar, preferably at standard pressure.

During the performance of step (c), the feed rate of solution (B1) or (B2) may be constant in each case or change within certain limits.

Step (c) of the inventive production process can be performed under air, under inert gas atmosphere, for example under noble gas or nitrogen atmosphere, or under reducing atmosphere. Examples of reducing gases include, for example, CO and SO₂. Preference is given to working under inert gas atmosphere.

During the performance of step (c), it is possible to draw off mother liquor from the stirred tank cascade or the stirred vessel without removing particles which have already precipitated. Mother liquor refers to water, water-soluble salts and possibly further additives present in solution. Possible water-soluble salts include, for example, alkali metal salts of counterions of transition metals, for example sodium acetate, potassium acetate, sodium sulfate, potassium sulfate, sodium nitrate, potassium nitrate, sodium halide, especially sodium chloride, potassium halide, and also additional salts, any additives used, and any excess alkali metal carbonate or alkali metal hydroxide, and also compound L. In addition, the mother liquor may comprise traces of soluble transition metal salts. Examples of suitable apparatuses for drawing off mother liquor without removing precipitated particles are sedimenters, inclined clarifiers, centrifuges, filters and clarifying apparatuses, and also separation apparatuses which utilize the difference in density of mother liquor and particles.

In one embodiment of the present invention, it is possible using an inclined clarifier divided into two sections to draw off mother liquor by removing not only precipitated particles but also gas bubbles introduced into the suspension by the stirring in the stirred vessel.

In one embodiment of the present invention, a precipitation of spherical particles is first brought about, for example by combining aqueous solution (A) and aqueous solution (B1) from a separate vessel, and then feeding in an aqueous solution (B2) via the separate vessel. In the separate vessel, which may, for example, be a stirred flow vessel, supplied solution (B2) is mixed with solution (B1). In a particular embodiment, the solution (B2) can be supplied to the separate vessel with a delivery rate which changes over time.

In one embodiment of the present invention, the procedure is to produce aqueous solution (B2) in a vessel connected to the stirred vessel and then to meter it into the stirred vessel. For this purpose, for example, it is possible first to prepare aqueous solution (B1) with a certain molar ratio of the transition metals in the vessel connected to the stirred vessel and then to meter it into the stirred vessel. Once a certain proportion of aqueous solution (B1) has been metered in, transition metal salts are metered in a different molar ratio of the transition metals and aqueous solution (B2) is prepared as a result. Then aqueous solution (B2) is metered into the stirred vessel.

In one embodiment of the present invention, a third aqueous solution (B3) comprising transition metal cations in a molar ratio which differs from the molar ratio of the transition metal cations of aqueous solution (B1) and (B2) is provided, and metered into a third stirred tank in a cascade or at another time into the stirred vessel.

In one embodiment of the present invention, the procedure is to select concentration of L and pH such that the concentration of soluble Ni²⁺ salts in the mother liquor is below 1000 ppm and the concentrations of soluble Co²⁺ salts and Mn²⁺ salts are each below 100 ppm, the concentration of soluble Ni²⁺ salts in the mother liquor preferably being below 400 ppm and the concentration of soluble Co²⁺ salts and Mn²⁺ salts each below 50 ppm. A lower limit for each of soluble Ni²⁺ salts, Co²⁺ salts and Mn²⁺ salts is 0.1 ppm. These amounts are each calculated based on the cation in question.

The concentration of L may remain constant or preferably change during the performance of step (c), and is more preferably lowered, for example by adding less compound L than is drawn off with mother liquor.

One embodiment of the present invention involves introducing a specific stirrer output of more than 2 W/l, preferably more than 4 W/l, into the suspension which forms.

One embodiment of the present invention involves employing a relatively higher mean energy input by stirring, e.g. 6 to 10 W/l, during the first third of the reaction time and a lower mean value, for example 3 to 5 W/l, in the subsequent two thirds.

In one embodiment of the present invention, step (c) can be performed over a period of 30 minutes up to 48 hours when a stirred vessel is employed.

If it is desirable to work in a stirred tank cascade, the duration of step (c) is theoretically unlimited, and the mean residence time may be in the range from 30 minutes up to 48 hours.

In one embodiment of the present invention, the procedure during step (c) may be to use a clarifying device to draw off mother liquor from the reaction mixture and to recycle any spherical particles also drawn off into the reaction mixture. The procedure may be to draw off mother liquor which does not comprise any spherical particles, or to draw off mother liquor comprising spherical particles and then to separate these from the mother liquor and to recycle them into the reaction mixture. Suitable clarifying devices are, for example, sedimenters, inclined clarifiers, centrifuges, filters and clarifying apparatuses, and also separating apparatuses which utilize the density difference of mother liquor and particles. Clarifying devices may be part of the stirred vessel or of the stirred tank cascade or separate devices.

This affords a suspension of spherical particles corresponding to the precursor in mother liquor.

In step (d) of the inventive production process, the spherical particles thus produced are removed from the mother liquor. The removal can be effected, for example, by filtration, centrifugation, decanting, spray drying or sedimentation, or by a combination of two or more of the aforementioned operations. Suitable apparatuses are, for example, filter presses, belt filters, spray dryers, hydrocyclones, inclined clarifiers or a combination of the aforementioned apparatuses.

To improve the removal, it is possible, for example, to wash with pure water or with an aqueous solution of alkali metal carbonate or alkali metal hydroxide, especially with an aqueous solution of sodium carbonate, potassium carbonate, sodium hydroxide, potassium hydroxide, lithium hydroxide or ammonia. Water and aqueous solution of alkali metal hydroxide, especially of sodium hydroxide, are preferred.

The washing can be effected, for example, with employment of elevated pressure or elevated temperature, for example 30 to 50° C. In another variant, the washing is performed at room temperature. The efficiency of the washing can be checked by analytical measures. For example, the content of transition metal(s) in the washing water can be analyzed.

If washing is effected with water rather than with an aqueous solution of alkali metal hydroxide, it is possible to check with the aid of conductivity studies on the washing water whether water-soluble substances, for example water-soluble salts, can still be washed out.

The removal of the spherical particles thus produced can be followed by drying. The drying can be performed, for example, with inert gas or with air. The drying can be performed, for example, at a temperature in the range from 30 to 150° C. If the drying is performed with air, it is observed in many cases that some transition metals are partially oxidized, for example Mn²⁺ to Mn⁴⁺ and Co²⁺ to Co³⁺, and blackening of the particles thus produced is observed.

In one embodiment of the present invention, no deagglomeration of the spherical particles thus produced is performed. In a preferred embodiment of the present invention, the spherical particles thus produced can be deagglomerated, for example, by sieving or windsifting.

The spherical particles may—according to the precipitant used—be transition metal carbonates, transition metal hydroxides or transition metal carbonate hydroxides

In one embodiment, the anions in the case of the transition metal carbonates are carbonate ions to an extent of up to 99.9 mol %, preferably to an extent of up to 99.5 mol %, based on all anions in the inventive particle in question.

In one embodiment, the anions in the case of the transition metal hydroxides are hydroxide ions to an extent of up to 99.9 mol %, preferably to an extent of up to 99.5 mol %, based on all anions in the inventive particle in question.

In one embodiment, the anions in the case of the transition metal hydroxides are carbonate ions and hydroxide ions to an extent of up to 99.9 mol %, preferably to an extent of up to 99.5 mol %, for example in a molar ratio in the range from 1:10 to 10:1, based on all anions in the inventive particle in question.

Further extraneous substances may be adsorbed onto spherical particles, for example one or more salts or anions from the mother liquor.

In step (e) of the inventive production process, the procedure may be, for example, to mix inventive particles with at least one lithium compound.

As the lithium compound, it is possible with preference to select lithium salts, for example Li₂O, LiOH, LiNO₃, Li₂SO₄, LiCl or Li₂CO₃, each in anhydrous form or, if it exists, as the hydrate, preference being given to LiOH and particular preference to Li₂CO₃.

The amounts of inventive particles and lithium compound are selected such that the desired stoichiometry of the cathode material is obtained. Preferably, inventive particles and lithium compound are selected such that the molar ratio of lithium to the sum of all transition metals and any M is in the range from 1:1 to 1.3:1, preferably 1.01:1 to 1.1:1.

A mixture is obtained.

In step (f) of the inventive production process, the mixture from step (e) is converted at a temperature in the range from 800 to 1000° C.

The conversion at 800 to 1000° C. can be performed in a furnace, for example in a rotary tube furnace, in a muffle furnace, in a pendulum furnace, in a roller hearth furnace or in a push-through furnace. Combinations of two or more of the aforementioned furnaces are also possible.

The conversion at 800 to 1000° C. can be performed over a period of 30 minutes to 24 hours. It is possible to convert at one temperature or to run a temperature profile.

When the conversion in step (f) is conducted at 1000° C. or at least 925° C. over a very long period, for example of 24 hours, diffusion of the cations of nickel, manganese, cobalt and any M can be observed. This diffusion may be desirable. For production of inventive spherical particles, however, it is preferable to conduct a conversion at 1000° C. or preferably 925° C. over a shorter period, for example 30 minutes to 4 hours. If production of inventive particles at 950° C. is desirable, preference is given to a period in the range from 30 minutes to 4 hours, and at a temperature of 900° C. a range from 30 minutes to 6 hours.

It is possible to work with crucibles having a base area—length times width—of at least 700 cm², called large crucibles, for example in push-through furnaces. In one embodiment of the present invention, it is possible to use crucibles having a high filling level, for example with a filling of up to 80% by volume, preferably even up to 90% by volume, determined at the start of step (f).

The performance of the inventive production process affords inventive particles.

The present invention further provides for the use of inventive particles as or for production of cathode material for lithium ion batteries.

Cathode material may, as well as inventive particles, comprise carbon in an electrically conductive polymorph, for example in the form of carbon black, graphite, graphene, carbon nanotubes or activated carbon.

Cathode material may further comprise at least one binder, for example a polymeric binder.

Suitable binders are preferably selected from organic (co)polymers. Suitable (co)polymers, i.e. homopolymers or copolymers, may be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

Polyacrylonitrile is understood in the context of the present invention to mean not only polyacrylonitrile homopolymers but also copolymers of acrylonitrile with 1,3-butadiene or styrene. Preference is given to polyacrylonitrile homopolymers.

In the context of the present invention, polyethylene is understood to mean not only homopolyethylene but also copolymers of ethylene which comprise at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is understood to mean not only homopolypropylene but also copolymers of propylene which comprise at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is understood to mean not only homopolymers of styrene but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binders are selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binders are selected from halogenated (co)polymers, especially from fluorinated (co)polymers. Halogenated or fluorinated (co)polymers are understood to mean those (co)polymers comprising, in copolymerized form, at least one (co)monomer having at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Electrically conductive carbonaceous material can be selected, for example, from graphite, carbon black, carbon nanotubes, graphene and mixtures of at least two of the aforementioned substances. In the context of the present invention, electrically conductive carbonaceous material can also be referred to as carbon (B) for short.

In one embodiment of the present invention, electrically conductive carbonaceous material is carbon black. Carbon black may be selected, for example, from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, electrically conductive carbonaceous material is partially oxidized carbon black.

In one embodiment of the present invention, electrically conductive carbonaceous material comprises carbon nanotubes. Carbon nanotubes (CNTs for short), for example single-wall carbon nanotubes (SW CNTs) and preferably multiwall carbon nanotubes (MW CNTs), are known per se. A process for production thereof and some properties are described, for example, by A. Jess et al, in Chemie Ingenieur Technik 2006, 78, 94-100.

In one embodiment of the present invention, carbon nanotubes have a diameter in the range from 0.4 to 50 nm, preferably 1 to 25 nm.

In one embodiment of the present invention, carbon nanotubes have a length in the range from 10 nm to 1 mm, preferably 100 nm to 500 nm.

In the context of the present invention, graphene is understood to mean almost ideally or ideally two-dimensional hexagonal carbon crystals of analogous structure to individual graphite layers.

In one embodiment of the present invention, the weight ratio of inventive particles and electrically conductive carbonaceous material is in the range from 200:1 to 5:1, preferably 100:1 to 10:1.

A further aspect of the present invention is a cathode comprising inventive particles, at least one electrically conductive carbonaceous material and at least one binder.

Inventive particles and electrically conductive carbonaceous material have been described above.

The present invention further provides electrochemical cells produced using at least one inventive cathode. The present invention further provides electrochemical cells comprising at least one inventive cathode.

In one embodiment of the present invention, cathode material produced in accordance with the invention comprises:

in the range from 60 to 98% by weight, preferably 70 to 96% by weight, of inventive particles,
in the range from 1 to 20% by weight, preferably 2 to 15% by weight, of binder, in the range from 1 to 25% by weight, preferably 2 to 20% by weight, of electrically conductive carbonaceous material.

The geometry of inventive cathodes can be selected within wide limits. It is preferable to configure inventive cathodes in thin films, for example in films with a thickness in the range from 10 μm to 250 μm, preferably 20 to 130 μm.

In one embodiment of the present invention, inventive cathodes comprise a foil or film, for example a metal foil, especially an aluminum foil, or a polymer film, for example a polyester film, which may be untreated or siliconized.

The present invention further provides for the use of inventive cathode materials or inventive cathodes in electrochemical cells. The present invention further provides a process for producing electrochemical cells using inventive cathode material or inventive cathodes. The present invention further provides electrochemical cells comprising at least one inventive cathode material or at least one inventive cathode.

Inventive electrochemical cells comprise a counterelectrode which, in the context of the present invention, is defined as the anode and which may, for example, be a carbon anode, especially a graphite anode, a lithium anode, a silicon anode or a lithium titanate anode.

Inventive electrochemical cells may, for example, be batteries or accumulators.

Inventive electrochemical cells may, as well as anode and inventive cathode, comprise further constituents, for example conductive salt, nonaqueous solvent, separator, output conductor, for example made of a metal or an alloy, and also cable connections and housing.

In one embodiment of the present invention, inventive electrical cells comprise at least one nonaqueous solvent which may be liquid or solid at room temperature, preferably selected from polymers, cyclic or noncyclic ethers, cyclic and noncyclic acetals, and cyclic or noncyclic organic carbonates.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably doubly methyl- or ethyl-capped polyalkylene glycols.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (III) and (IV)

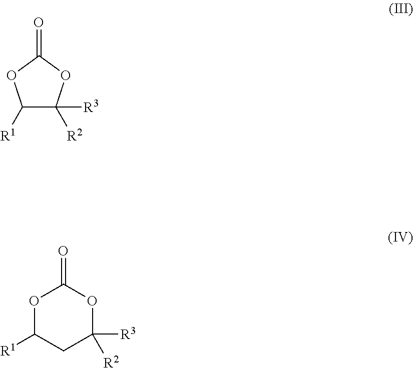

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (V).

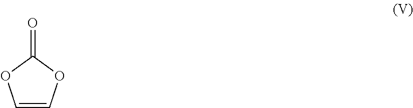

Preference is given to using the solvent(s) in what is called the anhydrous state, i.e. with a water content in the range from 1 ppm to 0.1% by weight, determinable, for example, by Karl Fischer titration.

Inventive electrochemical cells further comprise at least one conductive salt. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂ where n is an integer in the range from 1 to 20, LiN(SO₂F)₂, Li₂SiF₆, LiSbF₆, LiAlCl₄, and salts of the general formula (CₙF₂ₙ₊₁SO₂)ₜYLi where t is defined as follows:

t=1 when Y is selected from oxygen and sulfur,
t=2 when Y is selected from nitrogen and phosphorus, and
t=3 when Y is selected from carbon and silicon.

Preferred conductive salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

In one embodiment of the present invention, inventive electrochemical cells comprise one or more separators by which the electrodes are mechanically separated from one another. Suitable separators are polymer films, especially porous polymer films, which are unreactive toward metallic lithium. Particularly suitable materials for separators are polyolefins, especially porous polyethylene films and porous polypropylene films.

Polyolefin separators, especially of polyethylene or polypropylene, may have a porosity in the range from 35 to 45%. Suitable pore diameters are, for example, in the range from 30 to 500 nm.

In another embodiment of the present invention, separators may be selected from PET nonwovens filled with inorganic particles. Such separators may have a porosity in the range from 40 to 55%. Suitable pore diameters are, for example, in the range from 80 to 750 nm.

Inventive electrochemical cells further comprise a housing which may be of any shape, for example cuboidal or in the shape of a flat cylinder. In one variant, the housing used is a metal foil elaborated as a pouch.

Inventive electrochemical cells give a high voltage and are notable for high energy density and good stability. More particularly, the inventive electrochemical cells have better cycling stability compared to those electrochemical cells which are produced using cathode materials with comparable transition metal ratio in which the particles have an essentially constant composition in the radial dimension. Inventive electrochemical cells still have a high energy density even at high operating temperatures, e.g. 60° C., even after 100 to 200 cycles.

Inventive electrochemical cells can be combined with one another, for example in series connection or in parallel connection. Series connection is preferred.

The present invention further provides for the use of inventive electrochemical cells in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The use of inventive electrochemical cells in devices offers the advantage of a longer operating time prior to recharging. If the intention were to achieve an equal run time with electrochemical cells with lower energy density, a higher weight for electrochemical cells would have to be accepted.

The performance of steps (a) to (d) of the process of the invention affords spherical particles of a precursor, which likewise form part of the subject matter of the present invention and are also referred to as inventive precursor. Spherical particles of this kind comprise a mixed carbonate or hydroxide of nickel, cobalt and manganese and optionally at least one further metal M selected from Mg and Al and/or one or more transition metals selected from Ti, Fe, Cr and V, where—based on the total metal content—nickel is present in the range from 45 to 55 mol %, cobalt in the range from 17 to 34 mol %, manganese in the range from 15 to 35 mol % and any M in a total amount in the range from zero to 20 mol %, preferably up to 5 mol %, and where the proportion of nickel, plotted over the radius of the particles in question, in the outer region of the particles is at least 10 mol % below the proportion in the core, and where the manganese content, plotted over the radius of the particles in question, in the outer region of the particles is at least 10 mol % above the proportion in the core, and where mol % are based on the total content of transition metal.

The aforementioned precursor can be used to produce inventive particles in a particularly efficient manner.

If an aforementioned precursor is subjected to thermal treatment at 950 to 1000° C. for 24 hours or longer, however, it is subsequently observed that—probably because of diffusion—the transition metals are distributed homogeneously over the cross section of the corresponding particles.

The invention is illustrated further by working examples.

General remarks: liters should be understood to mean standard liters unless stated otherwise. Percentages in the context of the present invention are % by weight unless explicitly stated otherwise.

I. Production of Precursors for Inventive Spherical Particles

I.1 Production of Transition Metal Hydroxide TH.1

The examples and comparative experiments were performed in a reactor system having a total volume of 8 l, and the reactor system comprised a stirred tank having a volume of 7 l and an inclined clarifier having a volume of 1 l. Using an inclined clarifier having an angle of inclination of 35° and an effective cross section of 5 cm², it was possible during the reaction to draw mother liquor off from the stirred tank using a pump without simultaneously withdrawing solids.

At the start, the reaction system was filled with 8 l of ammonium sulfate solution having a concentration of 40 g/l and heated to 45° C.

The contents of the stirred tank were mixed constantly during the reaction, performing mechanical work of about 45 watts on the contents. The specific power input in the stirred tank was thus about 6.4 watts per liter. In the inclined clarifier, no stirrer output was introduced.

The stirred tank was equipped with a pitched blade stirrer and baffles. The stirrer output was measured using an electric motor with torque measurement from speed and torque. In addition, the stirred tank had several metering units with metering pumps, and also an electrode for pH measurement and a temperature sensor. In addition, a fill level sensor was present in the stirred tank, and this regulated the discharge pump at the liquid-side connection of the separation apparatus such that the level in the stirred tank remains essentially constant. Solids were recycled from the separation apparatus back into the stirred tank.

The gas space—about 2 liters—in the stirred tank was purged with 40 l/h of nitrogen during the performance of the precipitation.

The following aqueous solutions were used:

Aqueous solution (A.1): comprised 5.84 mol of NaOH per kg of solution and 1.8 mol of NH₃ per kg of solution, produced from 25% by weight of aqueous NaOH and 25% by weight of aqueous ammonia solution.

Aqueous solution (B1.1): comprised 0.967 mol per kg of solution of nickel sulfate, 0.333 mol per kg of solution of cobalt sulfate, and 0.353 mol per kg of solution of manganese sulfate, produced by dissolution of the corresponding hydrate complexes in water.

Aqueous solution (B2.1): comprised 0.584 mol per kg of solution of nickel sulfate, 0.333 mol per kg of solution of cobalt sulfate, and 0.733 mol per kg of solution of manganese sulfate, produced by dissolution of the corresponding hydrate complexes in water.

Aqueous solution (C.1): comprised 6.25 mol of NaOH per kg of solution.

Aqueous solutions (A.1), (B1.1) and (B2.1) were metered in by means of metering pumps; solution (C.1) was metered in such that the pH in the stirred tank remained constant (pH regulation).

### Experimental Procedure

The ammonium sulfate solution was adjusted to pH 11.82 by adding solution (C.1), measured in cooled solution at 23° C. Then the metering pumps were used to meter the solutions (B1.1), (B2.1) and (A.1) at constant mass flow rate (800/200/495 g/h) into the turbulent zone close to the stirrer blades of the stirred tanks of the reactor system. By means of a regulating device, the pH was kept constant at 11.58 (measured at 23° C.) by means of addition of solution (C.1). This formed a suspension of transition metal hydroxide (molar ratio in the particles: Ni:Co:Mn=54:20:26). After 12 hours, the flow rates of (B1.1) and (B2.1) were altered such that a flow rate of 200 g/h for (B1.1) and 800 g/h for (B2.1) had been attained after 14 hours (molar composition Ni:Co:Mn=40:20:40). The change in the flow rates was linear, i.e. with a constant change in the flow rates per unit time. Then the flow rates of (B1.1) and (B2.1) were left at 200 g/h and 800 g/h respectively for 0.5 hour.

The total duration of the metered addition was 26.5 hours, then the mixture was stirred without feeding for a further 15 minutes.

This gave a suspension of inventive transition metal hydroxide TH.1 which had a molar Ni:Co:Mn ratio of 48:21:31. The transition metal hydroxide suspension present in the stirred tank and inclined clarifier was filtered through a suction filter, and the filtercake was washed with water and dried at 105° C. over a period of 18 hours. The particles of precursor thus obtainable had a composition of 31.0% by weight of nickel, 13.7% by weight of cobalt and 18.7% by weight of manganese, based in each case on the particles, and were in partly oxidized form. In the outer region of the particles, the concentration of manganese was 14% by weight higher than in the core in each case. In the outer region of the particles, the concentration of nickel was 14% lower than in the core.

The particles were sieved (mesh size 32 μm; coarse material: 0.3%) and the tamped density was determined (2.2 kg/l). A portion was suspended in water and the particle size was determined by light scattering (Malvern Mastersizer 2000). The median particle size D50 was 12.8 μm, with narrow particle diameter distribution: D10=8.3 μm; D90=19.6 μm.

I.2 Production of Transition Metal Hydroxide TH.2

The procedure was as described in I.1, except that the following solutions were used:

Aqueous solution (A.2): comprised 6.25 mol of NaOH per kg of solution, but no ammonia.

Over the first 12 hours, metering pumps were used to meter in solutions (B1.1), (B2.1) and (A.2) at constant mass flow rate (760 g/h, 190 g/h, 489 g/h). This formed a suspension of transition metal hydroxide (molar ratio in the particles: Ni:Co:Mn=54:20:26). After 12 hours, the flow rates of (B1.1) and (B2.1) were altered such that a flow rate of 190 g/h for (B1.1) and 760 g/h for (B2.1) had been attained after 14 hours. In addition, after 12 hours, the target value was lowered by 0.2 pH unit, based on the pH at the start of the reaction, after 15 hours by a further 0.4 pH unit, after 18 hours by a further 0.5 pH unit and after 20 hours by a further 0.6 pH unit.

This gave inventive spherical particles of TH.2. The median particle diameter D50 was 10.5 μm, with a narrow particle diameter distribution: D10=6.6 μm; D90=16.4 μm. In the outer region of the particles, the concentration of manganese was 14% by weight higher than in the core in each case. In the outer region of the particles, the concentration of nickel was 14% lower than in the core.

II. Method for Production of Inventive Spherical Particles

General Method Using the Example of TH.1:

TH.1 was mixed intimately with finely ground lithium carbonate, and the molar ratio of lithium relative to the sum of the transition metals present was 1.10. A portion (40 g) of this mixture was treated thermally in rectangular crucibles of sintered alumina in a muffle furnace (air atmosphere; maximum temperature: 900° C.; heating rate 3 K/min; hold points at 300° C. and 600° C.; hold time for all stages: 6 hours in each case). After cooling to room temperature, the calcined material was triturated in a mortar and then sieved (mesh size 32 μm; no coarse material). About 30 g of inventive spherical particles SP.1 were obtained in the form of virtually agglomerate-free powder, which was processable to give the inventive electrodes.

Particle diameter (D50), tamped density and residual content of lithium carbonate (Li₂CO₃) of the inventive spherical particles SP.1 were determined.

In addition, the same process was used for thermal treatment of portions of 80 g of the mixture of TH.1 and Li₂CO₃, using the same crucibles (double the crucible charge).

The comparative material used was a transition metal hydroxide of the formula Ni_{0.5}Co_{0.2}Mn_{0.3}(OH)₂ for which a homogeneous distribution of the transition metal cations over the cross section of the particles was observed.

TABLE 1
Properties of inventive spherical particles and of comparative material

| | SP.1 | | Comparative material | |
|---|---|---|---|---|
| Crucible | % by wt. of | Tamped density | % by wt. of | Tamped density |
| charge | Li₂CO₃ | (kg/l) | Li₂CO₃ | (kg/l) |
| 40 g | 0.25 | 2.49 | 0.31 | 2.26 |
| 80 g | 0.25 | 2.43 | 0.86 | 2.32 |

In addition, SP.1 and the corresponding comparative material were examined for processability to agglomerate-free powders. The processing of SP.1 was much simpler than that of comparative materials. More particularly, the hardness of freshly thermally treated SP.1 was much lower, which enabled processing without energy-intensive grinding operations. The comparative material had to be triturated in a mortar for a prolonged period prior to sieving, in order that a sievable powder was obtainable.

The hardness of freshly thermally treated SP.1 and that of the comparative material were determined semiquantitatively by the measurement of the force to be expended and resulting penetration depth under the action of a metal rod of diameter 6 mm at right angles to the surface of the calcination material present in the crucible immediately after cooling to room temperature. The force was increased until distinct cracks were evident in the calcination material or a penetration depth of 5 mm had been attained. For SP.1, a force of only 15 N was necessary to reach penetration depth 5 mm, without formation of cracks. For the comparative material, distinct cracks in the calcination material were found only at 30 N; the penetration depth was only 1.5 mm.

III. General Method for Production of Inventive Electrodes and Inventive Electrochemical Cells

Binder (BM.1): Polymer of vinylidene fluoride, as a solution, 10% by weight in NMP, commercially available as Kynar® HSV900 from Arkema, Inc.

Electrically Conductive Carbonaceous Materials:

Carbon 1: Carbon black, BET surface area of about 60 m²/g, commercially available as “Super C65” from Timcal

Carbon 2: Graphite, commercially available as “SFG6L” from Timcal

Figures in % relate to percent by weight unless explicitly stated otherwise.

General Method Using the Example of Inventive Spherical Particles SP.1:

0.87 g of carbon 1, 1.46 g of carbon 2 and 17.25 g of binder (BM.1) were mixed with addition of 19.5 g of N-methylpyrrolidone (NMP) to give a paste. In a next step, 4.35 g of this paste were mixed with 6.0 g of inventive spherical particles SP.1. An aluminum foil of thickness 30 μm was coated with the above-described paste (active material loading about 12 mg/cm²). After drying at 105° C., circular parts of the aluminum foil thus coated (diameter 17.5 mm) were punched out. Using the electrode thus obtainable (cat-1), inventive electrochemical cells EZ.1 were produced.

The electrolyte used was a 1 mol/1 solution of LiPF₆ in ethylene carbonate/diethyl carbonate (1:1 based on parts by mass), which additionally comprised 2% by weight of vinylidene carbonate. The anode consisted of a graphite-coated copper foil (An-1) which was separated from the cathode by a separator made from glass fiber paper.

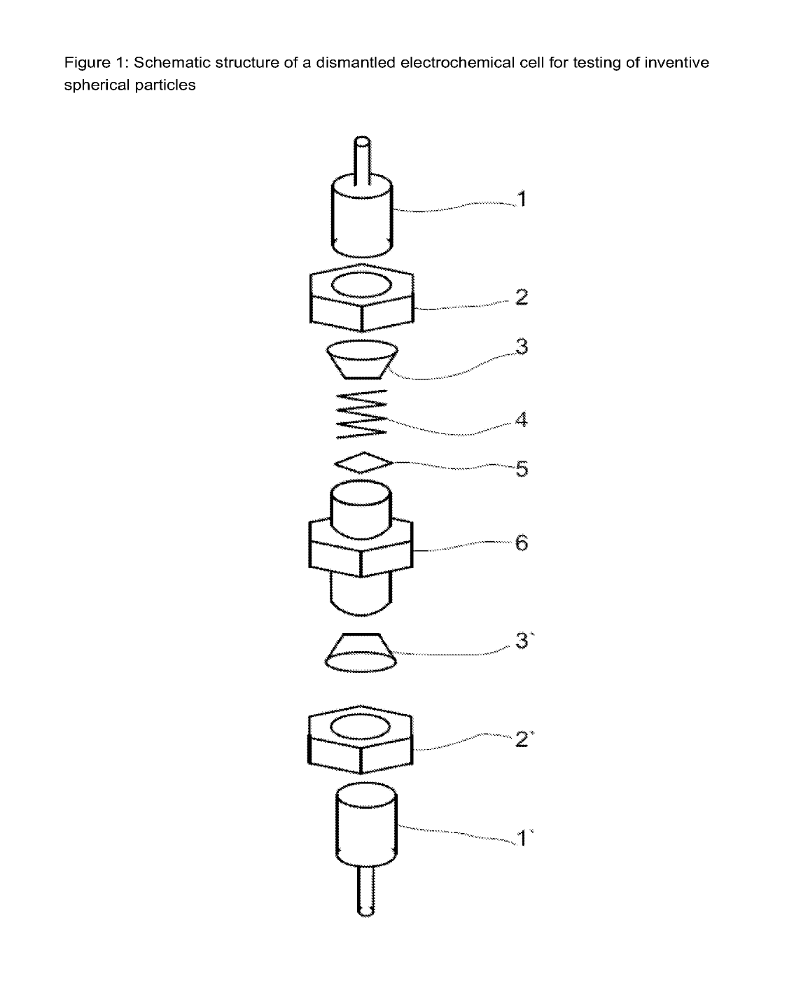

The test cell used was a setup according to FIG. 1. In the course of assembly of the cell, it was put together from the bottom upward according to the schematic diagram, FIG. 1. In FIG. 1, the anode side is at the top, the cathode side at the bottom.

The labels in FIG. 1 mean:
1, 1′ Bolts
2, 2′ Nuts
3, 3′ Sealing ring—two in each case; the second, somewhat smaller sealing ring in each case is not shown here
4 Spiral spring
5 Steel output conductor
6 Housing

Cathode (cat-1) was applied to the bolt on the cathode side 1′. Subsequently, a separator made from glass fiber paper, separator thickness: 0.5 mm, was placed onto cathode (cat-1).

Electrolyte was dripped onto the separator. Anode (An-1) was placed onto the impregnated separators. The output conductor 5 used was a stainless steel cylinder which was applied directly to the anode. Subsequently, the seals 3 and 3′ were added and the parts of the test cell were screwed together. By means of the steel spring which took the form of a spiral spring 4, and through the pressure which was generated by the screw connection with anode bolt 1, electrical contact was ensured.

This gave inventive electrochemical cells EC.1.

The procedure was analogous with the comparative material.

Subsequently, the cells were formed at room temperature and cycled at 60° C. The cycling current was 75 A/kg, based on the active material of the cathode, and the rate capability was also determined at 150 Ah/kg, 300 Ah/kg and 450 Ah/kg at intervals of about 50 cycles. The voltage range selected was 2.8 volts to 4.3 volts.

The charging was conducted at 75 A/kg until the upper switch-off voltage had been attained, then charging was effected at constant voltage for another 30 minutes. The discharging was always conducted only until the lower switch-off voltage had been attained.

TABLE 2
Capacity in Ah/kg of inventive electrochemical cells and comparative cells

| Cycle | EC. 1 | C-EC. 2 |
|---|---|---|
| 10 | 186 | 173 |
| 100 | 173 | 157 |
| 200 | 162 | 135 |

1. Spherical particles which have an average composition of general formula (I):
Liᵢ₊ₓ(NiₐCo_{b}Mn_{c}M_{d})₁₋ₓO₂ (I)
wherein:
M is Mg or Al and/or one or more transition metals selected from the group consisting of Ti, Fe, Cr and V,
a is in a range from 0.45 to 0.55,
b is in a range from 0.17 to 0.34,
c is in a range from 0.15 to 0.35,
d is in a range from zero to 0.2,
where: a+b+c+d=1,
x is in a range from 0.005 to 0.2,
wherein a carbonate content, calculated as Li₂CO₃, is in a range from 0.01 to 0.3% by weight, based on overall particles, and a proportion of nickel, plotted against a radius of the particles, in an outer region of the particles is at least 10 mol % below a proportion in a core, and a manganese content, plotted against the radius of the particles, in an outer region of the particles is at least 10 mol % above a proportion in the core, and where mol % are based on a total transition metal content, where the outer region of the particles is the region which is not the core.

2. The spherical particles of claim 1, wherein a nickel content averages at least 50 mol %, based on transition metal content.

3. The spherical particles of claim 1, wherein a cobalt content, plotted against the radius of the particles, is essentially constant.

4. The spherical particles of claim 1, wherein a concentration of at least one of the transition metals selected from the group consisting of nickel and manganese changes within the particle in a manner of a constant function or in steps of not more than 10 mol %.

5. The spherical particles of claim 1, wherein concentrations of nickel and manganese, plotted against the radius of the particles, do not have any turning points.

6. The spherical particles of claim 1, which have a median diameter (D50) in a range from 1 to 20 μm.

7. The spherical particles of claim 1, wherein a ratio of median diameters (D10)/(D50) is at least 0.5 and a ratio (D90)/(D50) is not more than 1.6.

8. The spherical particles of claim 1, wherein the core makes up to 50% by weight of the respective particle.

9. A process for producing the spherical particles of claim 1, comprising:
(a) performing a precipitation of mixed transition metal carbonates, transition metal hydroxides or transition metal carbonate hydroxides in a stirred tank cascade of at least two stirred tanks or in a stirrer vessel, by initially charging an aqueous solution of compound L where compound L may serve as ligand for at least one of the transition metals, bringing about the precipitation given different transition metal concentrations by
(a1) feeding solutions (B1) and (B2) into different stirred tanks in the stirred tank cascade or by
(a2) feeding solutions (B1) and (B2) into the stirred vessel at metering rates which change over time,
wherein solution (B1) comprises at least three transition metal salts selected from the group consisting of nickel salts, cobalt salts and manganese salts, and solution (B2) comprises at least two transition metal salts selected from the group consisting of cobalt salts and manganese salts, and optionally a nickel salt, the aqueous solutions (B1) and (B2) having different molar ratios of nickel and manganese,
(b) removing the spherical particles thus precipitated,
(c) mixing the spherical particles with at least one lithium compound selected from the group consisting of LiOH, Li₂O and Li₂CO₃, and
(d) converting the spherical particles at a temperature in the range from 800 to 1000° C.

10. The process of claim 9, wherein (a2) is performed by first bringing about a precipitation of spherical particles and then feeding in a solution (B2) via a separate vessel.

11. The process of claim 9, wherein a clarifying device is used during (a) to draw off mother liquor from the reaction mixture and it is optionally recycled into the reaction mixture with spherical particles drawn off.

12. The process of claim 9, wherein (a) is performed at a pH of the reaction mixture which remains essentially constant during the performance.

13. An electrochemical cell comprising the spherical particles of claim 1.

14. An electrode comprising the spherical particles of claim 1.

15. Spherical particles comprising:
a mixed carbonate or hydroxide of nickel, cobalt and manganese, and
optionally at least one further metal M selected from the group consisting of Mg and Al and/or one or more transition metals selected from Ti, Fe, Cr and V,
where, based on a total metal content, nickel is present in a range from 45 to 55 mol %, cobalt in a range from 17 to 34 mol %, manganese in a range from 15 to 35 mol % and M in a total amount in a range from zero to 20 mol %, and where a proportion of nickel, plotted over a radius of the particles, in an outer region of the particles is at least 10 mol % below a proportion in a core, and where a manganese content, plotted over the radius of the particles, in the outer region of the particles is at least 10 mol % above a proportion in the core, and where mol % are based on a total content of transition metal, and where the outer region of the particles is the region which is not the core.
